(19) United States
(12) Patent Application Publication
(10) Pub. No.: US 2007/0151866 A1
(43) Pub. Date: Jul. 5, 2007

(54) Substrate polishing with surface pretreatment

(75) Inventors: Zhihong Wang, Santa Clara, CA (US); You Wang, Cupertino, CA (US); Renhe Jia, Berkeley, CA (US); Stan D. Tsai, Fremont, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/326,636

(22) Filed: Jan. 5, 2006

(51) Int. Cl. B23H 9/00; B23H 5/06; C25F 7/00; B23H 7/00

(52) U.S. Cl. 205/640; 438/692; 205/662

(57) ABSTRACT

A method for processing a surface of a substrate is provided. In one embodiment, the method includes pretreating a conductive layer of the substrate by exposing the substrate to a pretreatment fluid, and planarizing the pre-treated substrate in the system.

### BACKGROUND OF THE INVENTION

1.Field of the Invention

The present invention generally relates to a method for processing a surface of a substrate. More specifically, the present invention provides a method for pretreating the surface of a substrate in a planarization process.

2.Background of the Related Art

Reliably producing sub-half micron and smaller features is one of the key technologies for the next generation of very large scale integration (VLSI) and ultra large-scale integration (ULSI) of semiconductor devices. However, as the limits of circuit technology are pushed, the shrinking dimensions of interconnects in VLSI and ULSI technology have placed additional demands on processing capabilities. Reliable formation of interconnects is important to VLSI and ULSI success and to the continued effort to increase circuit density and quality of individual substrates and die.

Multilevel interconnects are formed using sequential material deposition and material removal techniques on a substrate surface to form features therein. As layers of materials are sequentially deposited and removed, the uppermost surface of the substrate may become non-planar across its surface and require planarization prior to further processing. Planarization or “polishing” is a process in which material is removed from the surface of the substrate to form a generally even, planar surface. Planarization is useful in removing excess deposited material, removing undesired surface topography, and surface defects, such as surface roughness, agglomerated materials, crystal lattice damage, scratches, and contaminated layers or materials to provide an even surface for subsequent photolithography and other semiconductor manufacturing processes. One conventional process for planarization is by chemical mechanical polishing (CMP), which planarizes a layer by chemical activity and mechanical activity.

A variation of CMP, which is particularly useful for copper polishing, is electrochemical mechanical polishing (ECMP). In ECMP technique, conductive material is removed from the substrate surface by electrochemical dissolution while concurrently polishing the substrate, typically with reduced mechanical abrasion as compared to conventional CMP process. The electrochemical dissolution is performed by applying a bias between a cathode and the substrate surface and this remove conductive material from the substrate surface into surrounding electrolyte.

An efficient and conformal removal rate of the conductive material during polishing is desired to improve the surface planarization and tool throughput. In general, a passivation layer, which may act as a corrosion inhibitor, may be formed over the conductive material during polishing to ensure that polishing occurs primarily where contact is made between the conductive material and polishing pad. Passivation agents create a passivation layer in the recess areas of the conductive material. The passivation layer prevents the recess areas from being polished until the surrounding higher material has been removed, thereby enhancing planarity while polishing. However, passivation layer may also reduce the removal rate of the conductive material owing to the surface protection layer formed therein. As such, the removal rate and the amount of passivation must be balanced to yield good polishing results without too severe an impact on throughput.

Therefore, there is a need in the art for an improved method for removing conductive material, such as copper, tungsten and the like, from a substrate.

### SUMMARY OF THE INVENTION

A method for processing a surface of a substrate is provided. In one embodiment, the method includes pretreating a conductive layer of a substrate by exposing the layer to a pretreatment fluid, and planarizing the pre-treated substrate.

In another embodiment, the method of pretreating a surface of a substrate includes pretreating a conductive surface of a substrate in a system by exposing the conductive surface to a pretreatment fluid comprising a corrosion inhibitor, and planarizing the pretreated substrate in the system in the presence of a polishing fluid.

In yet another embodiment, the method of pretreating a surface of a substrate includes passivating a conductive surface of a substrate by exposing the conductive surface to a pretreatment fluid, exposing the substrate to a polishing fluid, contacting the passivated surface of the substrate to a polishing surface, applying an electrical bias to the conductive surface, providing relative motion between the substrate and the polishing surface, and removing a portion of the conductive surface to planarize the substrate.

### BRIEF DESCRIPTION OF THE DRAWINGS

So that the manner in which the above recited aspects of the present invention are attained and can be understood in detail, a more particular description of embodiments of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a plan view of an electrochemical mechanical planarizing system;

FIG. 2 is a sectional view of one embodiment of a first electrochemical mechanical planarizing (ECMP) station of the system of FIG. 1;

FIG. 3A is a partial sectional view of the first ECMP station through two contact assemblies;

FIGS. 3B-C are sectional views of alternative embodiments of contact assemblies;

FIGS. 3D-E are sectional views of plugs;

FIGS. 4A and 4B are side, exploded and sectional views of one embodiment of a contact assembly;

FIG. 5 is a perspective view of one embodiment of a contact element;

FIG. 6 is a vertical sectional view of another embodiment of an ECMP station;

FIG. 7 is a flow diagram of one embodiment of a method for pretreating and polishing conductive materials;

FIGS. 8A-8E are schematic cross-sectional views illustrating a polishing process performed on a substrate according to one embodiment; and

FIGS. 9A and 9B illustrate a side view and a front view of an exemplary embodiment of a pretreatment station, e.g., a soak tank, according to one embodiment of the invention.

To facilitate understating, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION OF THE PREFERRED EMBODIMENT

In general, aspects of the inventions provide methods for removing conductive materials from a substrate surface that incorporates a pretreatment step. The inventions are described below in reference to a pretreatment step prior to the planarizing process for the removal of conductive materials from a substrate surface by a chemical mechanical polishing (CMP) or an electrochemical mechanical polishing (ECMP). In an exemplary embodiment described below, the process is illustratively performed in an electrochemical mechanical polishing (ECMP) system.

Apparatus

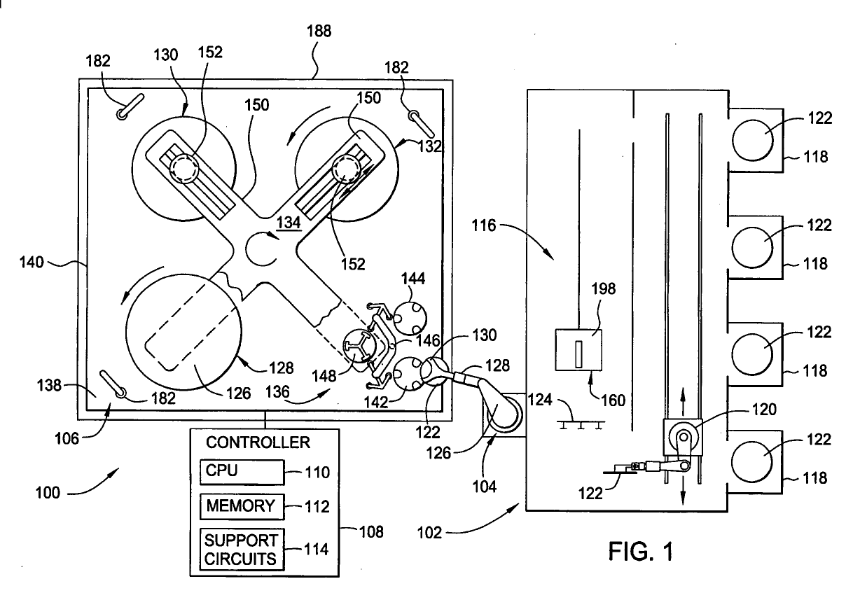

FIG. 1 is a plan view of one embodiment of a planarization system 100 for electrochemically processing a substrate. The exemplary system 100 generally comprises a pretreatment station 160, a factory interface 102, a loading robot 104, and a planarizing module 106. The loading robot 104 is disposed proximate the factory interface 102 and the planarizing module 106 to facilitate the transfer of substrates 122 therebetween.

A controller 108 is provided to facilitate control and integration of the modules of the system 100. The controller 108 comprises a central processing unit (CPU) 110, a memory 112, and support circuits 114. The controller 108 is coupled to the various components of the system 100 to facilitate control of, for example, the planarizing, cleaning, and transfer processes.

The factory interface 102 generally includes a cleaning module 116 and one or more wafer cassettes 118. An interface robot 120 is employed to transfer substrates 122 between the wafer cassettes 118, the cleaning module 116 and an input module 124. The input module 124 is positioned to facilitate transfer of substrates 122 between the planarizing module 106 and the factory interface 102.

The planarizing module 106 includes at least a first electrochemical mechanical planarizing (ECMP) station 128 and/or a CMP station 132, disposed in an environmentally controlled enclosure 188. Examples of planarizing modules 106 that can be adapted to benefit from the invention include MIRRA® Chemical Mechanical Planarizing Systems, MIRRA MESA™ Chemical Mechanical Planarizing Systems, REFLEXION® Chemical Mechanical Planarizing Systems, REFLEXION LK™ Chemical Mechanical Planarizing Systems, and REFLEXION LK Ecmp™ Chemical Mechanical Planarizing Systems, all available from Applied Materials, Inc. of Santa Clara, Calif. Other planarizing modules, including those that use processing pads, planarizing webs, or a combination thereof, and those that move a substrate relative to a planarizing surface in a rotational, linear or other planar motion, may also be adapted to benefit from the invention.

In the embodiment depicted in FIG. 1, the planarizing module 106 includes a bulk ECMP station 128, a second ECMP station 130 and a CMP station 132. Bulk removal of conductive material from the substrate is performed through an electrochemical dissolution process at the bulk ECMP station 128. After the bulk material removal at the bulk ECMP station 128, residual conductive material is removed from the substrate at the residual ECMP station 130 through a second electrochemical mechanical process. It is contemplated that more than one residual ECMP station 130 may be utilized in the planarizing module 106. It is contemplated that the Ecmp process methods described herein may be substituted with a CMP process.

A conventional chemical mechanical planarizing process is performed at the planarizing station 132 after processing at the residual ECMP station 130 by the barrier removal process described herein. An example of a conventional CMP process on a chemical mechanical polishing station for the barrier removal is described in U.S. patent application Ser. No. 10/187,857, filed Jun. 27, 2002, which is incorporated by reference in its entirety. It is contemplated that other CMP processes may be alternatively performed. As the CMP stations 132 are conventional in nature, further description thereof has been omitted for the sake of brevity.

It is contemplated that more than one ECMP station may be utilized to perform the multi-step removal process after the bulk removal process performed at a different station. Alternatively, each of the first and second ECMP stations 128, 130 may be utilized to perform both the bulk and multi-step conductive material removal on a single station. The multi-step process may include bulk and residual conductive material removal at a single station. It is also contemplated that all ECMP stations (for example 3 stations of the module 106 depicted in FIG. 1) may be configured to process the conductive material with a two step removal process.

The exemplary planarizing module 106 also includes a transfer station 136 and a carousel 134 that are disposed on an upper or first side 138 of a machine base 140. In one embodiment, the transfer station 136 includes an input buffer station 142, an output buffer station 144, a transfer robot 146, and a load cup assembly 148. The input buffer station 142 receives substrates from the input module 124 of the factory interface 102 by means of the loading robot 104. The loading robot 104 is also utilized to return polished substrates from the output buffer station 144 to the factory interface 102. The transfer robot 146 is utilized to move substrates between the buffer stations 142, 144 and the load cup assembly 148.

In one embodiment, the transfer robot 146 includes two gripper assemblies (not shown), each having pneumatic gripper fingers that hold the substrate by the substrate's edge. The transfer robot 146 may simultaneously transfer a substrate to be processed from the input buffer station 142 to the load cup assembly 148 while transferring a processed substrate from the load cup assembly 148 to the output buffer station 144. An example of a transfer station that may be used to advantage is described in U.S. Pat. No. 6,156,124, issued Dec. 5, 2000 to Tobin, which is herein incorporated by reference in its entirety.

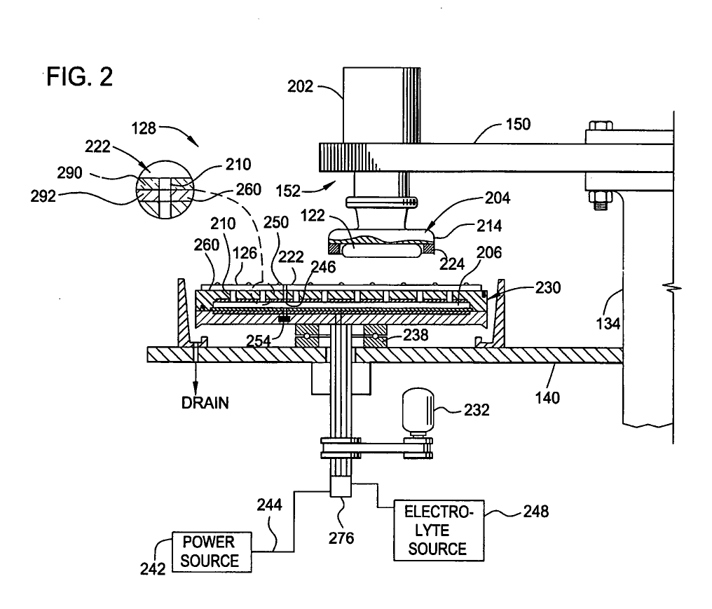

The carousel 134 is centrally disposed on the base 140. The carousel 134 typically includes a plurality of arms 150, each supporting a carrier head assembly 152. Two of the arms 150 depicted in FIG. 2 are shown in phantom such that the transfer station 136 and a planarizing surface 126 of the first ECMP station 128 may be seen. The carousel 134 is indexable such that the carrier head assemblies 152 may be moved between the planarizing stations 128, 130, 132 and the transfer station 136. One carousel that may be utilized to advantage is described in U.S. Pat. No. 5,804,507, issued Sep. 8, 1998 to Perlov, et al., which is hereby incorporated by reference in its entirety.

A conditioning device 182 is disposed on the base 140 adjacent each of the planarizing stations 128, 130, 132. The conditioning device 182 periodically conditions the planarizing material disposed in the stations 128, 130, 132 to maintain uniform planarizing results.

FIG. 2 depicts a sectional view of one of the carrier head assemblies 152 positioned over one embodiment of the bulk ECMP station 128. The second and third stations 130, 132 may be similarly configured. The carrier head assembly 152 generally comprises a drive system 202 coupled to a carrier head 204. The drive system 202 generally provides at least rotational motion to the carrier head 204. The carrier head 204 additionally may be actuated toward the bulk ECMP station 128 such that the substrate 122 retained in the carrier head 204 may be disposed against the planarizing surface 126 of the bulk ECMP station 128 during processing. The drive system 202 is coupled to the controller 108 that provides a signal to the drive system 202 for controlling the rotational speed and direction of the carrier head 204.

In one embodiment, the carrier head may be a TITAN HEAD™ or TITAN PROFILER™ wafer carrier manufactured by Applied Materials, Inc. Generally, the carrier head 204 includes a housing 214 and retaining ring 224 that defines a center recess in which the substrate 122 is retained. The retaining ring 224 circumscribes the substrate 122 disposed within the carrier head 204 to prevent the substrate from slipping out from under the carrier head 204 while processing. The retaining ring 224 can be made of plastic materials such as polyphenylene sulfide (PPS), polyetheretherketone (PEEK), and the like, or conductive materials such as stainless steel, Cu, Au, Pd, and the like, or some combination thereof. It is further contemplated that a conductive retaining ring 224 may be electrically biased to control the electric field during ECMP. Conductive or biased retaining rings tend to slow the polishing rate proximate the edge of the substrate. It is contemplated that other carrier heads may be utilized.

The first ECMP station 128 generally includes a platen assembly 230 that is rotationally disposed on the base 140. The platen assembly 230 is supported above the base 140 by a bearing 238 so that the platen assembly 230 may be rotated relative to the base 140. An area of the base 140 circumscribed by the bearing 238 is open and provides a conduit for the electrical, mechanical, pneumatic, control signals and connections communicating with the platen assembly 230.

Conventional bearings, rotary unions and slip rings, collectively referred to as rotary coupler 276, are provided such that electrical, mechanical, fluid, pneumatic, control signals and connections may be coupled between the base 140 and the rotating platen assembly 230. The platen assembly 230 is typically coupled to a motor 232 that provides the rotational motion to the platen assembly 230. The motor 232 is coupled to the controller 108 that provides a signal for controlling for the rotational speed and direction of the platen assembly 230.

A top surface 260 of the platen assembly 230 supports a processing pad assembly 222 thereon. The processing pad assembly 222 may be retained to the platen assembly 230 by magnetic attraction, vacuum, clamps, adhesives and the like.

A plenum 206 is defined in the platen assembly 230 to facilitate uniform distribution of a polishing fluid, such as an electrolyte, to the planarizing surface 126. A plurality of passages, described in greater detail below, are formed in the platen assembly 230 to allow electrolyte, provided to the plenum 206 from an electrolyte source 248, to flow uniformly though the platen assembly 230 and into contact with the substrate 122 during processing. It is contemplated that different polishing fluid compositions may be provided during different stages of processing.

The processing pad assembly 222 includes an electrode 292 and at least a planarizing portion 290. The electrode 292 is typically comprised of a conductive material, such as stainless steel, copper, aluminum, gold, silver and tungsten, among others. The electrode 292 may be solid, impermeable to electrolyte, permeable to electrolyte or perforated. At least one contact assembly 250 extends above the processing pad assembly 222 and is adapted to electrically couple the substrate being processed on the processing pad assembly 222 to the power source 242. The electrode 292 is also coupled to the power source 242 so that an electrical potential may be established between the substrate and electrode 292.

A meter (not shown) is provided to detect a metric indicative of the electrochemical process. The meter may be coupled or positioned between the power source 242 and at least one of the electrode 292 or contact assembly 250. The meter may also be integral to the power source 242. In one embodiment, the meter is configured to provide the controller 108 with a metric indicative of processing, such a charge, current and/or voltage. This metric may be utilized by the controller 108 to adjust the processing parameters in-situ or to facilitate endpoint or other process stage detection.

Optionally, a window 246 may be provided through the pad assembly 222 and/or platen assembly 230, and is configured to allow a sensor 254, positioned below the pad assembly 222, to sense a metric indicative of polishing performance. For example, the sensor 254 may be an eddy current sensor or an interferometer, among other sensors. The metric, provided by the sensor 254 to the controller 108, provides information that may be utilized for processing profile adjustment in-situ, endpoint detection or detection of another point in the electrochemical process. In one embodiment, the sensor 254 an interferometer capable of generating a collimated light beam, which during processing, is directed at and impinges on a side of the substrate 122 that is being polished. The interference between reflected signals is indicative of the thickness of the conductive layer of material being processed. One sensor that may be utilized to advantage is described in U.S. Pat. No. 5,893,796, issued Apr. 13, 1999, to Birang, et al., which is hereby incorporated by reference in its entirety.

Embodiments of the processing pad assembly 222 suitable for removal of conductive material from the substrate 122 may generally include a planarizing surface 126 that is substantially dielectric. Other embodiments of the processing pad assembly 222 suitable for removal of conductive material from the substrate 122 may generally include a planarizing surface 126 that is substantially conductive. At least one contact assembly 250 is provided to couple the substrate to the power source 242 so that the substrate may be biased relative to the electrode 292 during processing. Apertures 210, formed through the planarizing portion 290 and the electrode 292 and the any elements disposed below the electrode, allow the electrolyte to establish a conductive path between the substrate 112 and electrode 292.

In one embodiment, the planarizing portion 290 of the processing pad assembly 222 is a dielectric, such as polyurethane. Examples of processing pad assemblies that may be adapted to benefit from the invention are described in U.S. patent application Ser. No. 10/455,941, filed Jun. 6, 2003, entitled “Conductive Planarizing Article For Electrochemical Mechanical Planarizing”, and U.S. patent application Ser. No. 10/455,895, filed Jun. 6, 2003, entitled “Conductive Planarizing Article For Electrochemical Mechanical Planarizing,” both of which are hereby incorporated by reference in their entireties.

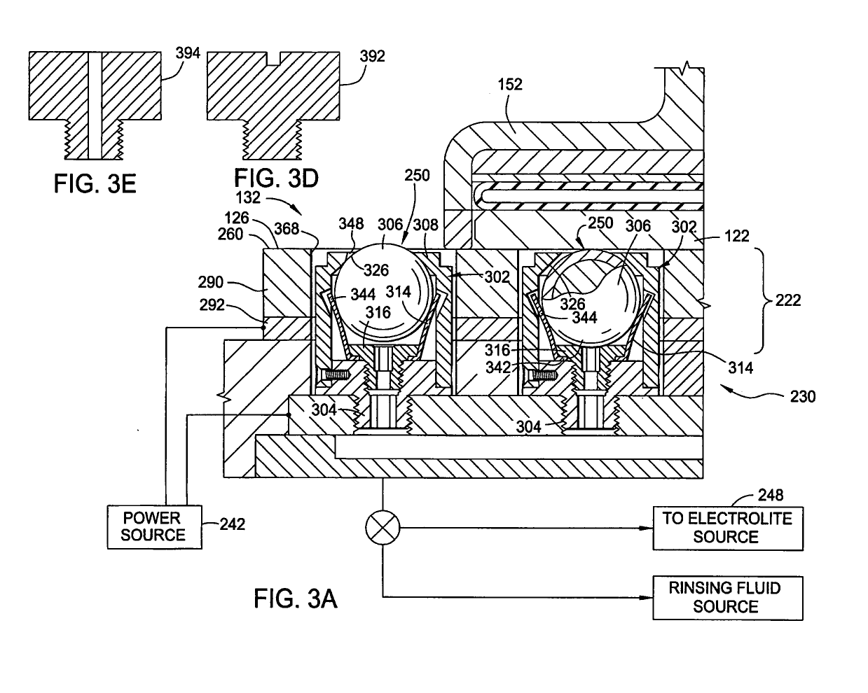

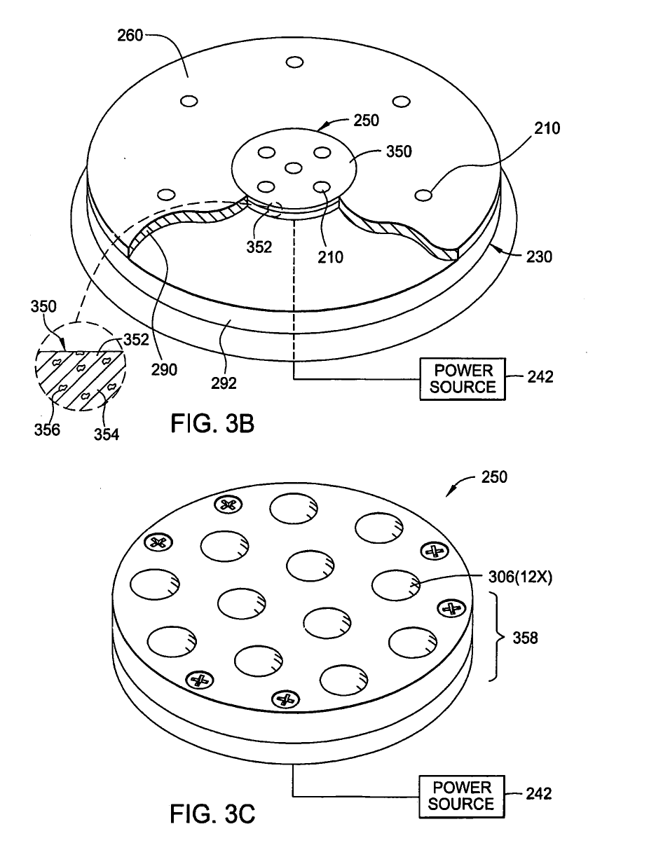

FIG. 3A is a partial sectional view of the first ECMP station 128 through two contact assemblies 250, and FIGS. 5A-C are side, exploded and sectional views of one of the contact assemblies 250 shown in FIG. 5A. The platen assembly 230 includes at least one contact assembly 250 projecting therefrom and coupled to the power source 242 that is adapted to bias a surface of the substrate 122 during processing. The contact assemblies 250 may be coupled to the platen assembly 230, part of the processing pad assembly 222, or a separate element. Although two contact assemblies 250 are shown in FIG. 3A, any number of contact assemblies may be utilized and may be distributed in any number of configurations relative to the centerline of the platen assembly 230.

The contact assemblies 250 are generally electrically coupled to the power source 242 through the platen assembly 230 and are movable to extend at least partially through respective apertures 368 formed in the processing pad assembly 222. The positions of the contact assemblies 250 may be chosen to have a predetermined configuration across the platen assembly 230. For predefined processes, individual contact assemblies 250 may be repositioned in different apertures 368, while apertures not containing contact assemblies may be plugged with a stopper 392 or filled with a nozzle 394 (as shown in FIGS. 3D-E) that allows flow of electrolyte from the plenum 206 to the substrate. One contact assembly that may be adapted to benefit from the invention is described in U.S. patent application Ser. No. 10/445,239, filed May 23, 2003, by Butterfield, et al., and is hereby incorporated by reference in its entirety.

Although the embodiments of the contact assembly 250 described below with respect to FIG. 3A depicts a rolling ball contact, the contact assembly 250 may alternatively comprise a structure or assembly having a conductive upper layer or surface suitable for electrically biasing the substrate 122 during processing. For example, as depicted in FIG. 3B, the contact assembly 250 may include a pad structure 350 having an upper layer 352 made from a conductive material or a conductive composite (i.e., the conductive elements are dispersed integrally with or comprise the material comprising the upper surface), such as a polymer matrix 354 having conductive particles 356 dispersed therein or a conductive coated fabric, among others. The pad structure 350 may include one or more of the apertures 210 formed therethrough for electrolyte delivery to the upper surface of the pad assembly. Other examples of suitable contact assemblies are described in U.S. Provisional Patent Application Ser. No. 60/516,680, filed Nov. 3, 2003, by Hu, et al., which is hereby incorporated by reference in its entirety.

In one embodiment, each of the contact assemblies 250 includes a hollow housing 302, an adapter 304, a ball 306, a contact element 314 and a clamp bushing 316. The ball 306 has a conductive outer surface and is movably disposed in the housing 302. The ball 306 may be disposed in a first position having at least a portion of the ball 306 extending above the planarizing surface 126 and at least a second position where the ball 306 is substantially flush with the planarizing surface 126. It is also contemplated that the ball 306 may move completely below the planarizing surface 126. The ball 306 is generally suitable for electrically coupling the substrate 122 to the power source 242. It is contemplated that a plurality of balls 306 for biasing the substrate may be disposed in a single housing 358 as depicted in FIG. 3C.

The power source 242 generally provides a positive electrical bias to the ball 306 during processing. Between planarizing substrates, the power source 242 may optionally apply a negative bias to the ball 306 to minimize attack on the ball 306 by process chemistries.

The housing 302 is configured to provide a conduit for the flow of electrolyte from the source 248 to the substrate 122 during processing. The housing 302 is fabricated from a dielectric material compatible with process chemistries. A seat 326 formed in the housing 302 prevents the ball 306 from passing out of the first end 308 of the housing 302. The seat 326 optionally may include one or more grooves 348 formed therein that allow fluid flow to exit the housing 302 between the ball 306 and seat 326. Maintaining fluid flow past the ball 306 may minimize the propensity of process chemistries to attack the ball 306.

The contact element 314 is coupled between the clamp bushing 316 and the adapter 304. The contact element 314 is generally configured to electrically connect the adapter 304 and ball 306 substantially or completely through the range of ball positions within the housing 302. In one embodiment, the contact element 314 may be configured as a spring form. It is also contemplated that a single contact assembly 250 may include a plurality of contact balls 306, an example of which is shown in FIG. 3C.

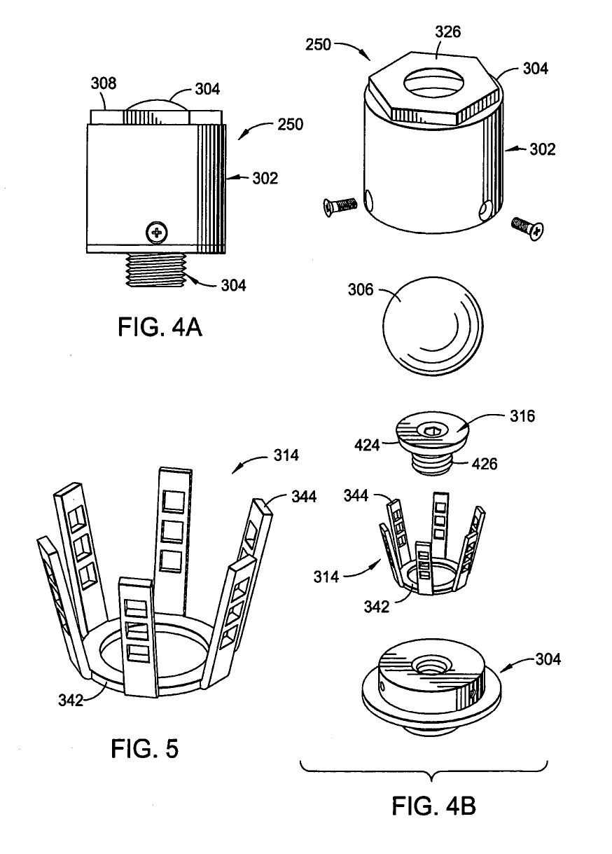

In the embodiments depicted in FIGS. 3A, 4A-B and 5, the contact element 314 includes an annular base 342 having a plurality of flexures 344 extending therefrom in a polar array. The flexure 344 is generally fabricated from a resilient and conductive material suitable for use with process chemistries. In one embodiment, the flexure 344 is fabricated from gold plated beryllium copper.

The clamp bushing 316 includes a flared head 424 having a threaded post 422 extending therefrom. The clamp bushing 316 may be fabricated from either a dielectric or conductive material, or a combination thereof, and in one embodiment, is fabricated from the same material as the housing 302. The flared head 424 maintains the flexures 344 at an acute angle relative to the centerline of the contact assembly 250 so that the flexures 344 of the contact elements 314 are positioned to spread around the surface of the ball 306 to prevent bending, binding and/or damage to the flexures 344 during assembly of the contact assembly 250 and through the range of motion of the ball 306.

The ball 306 may be solid or hollow and is typically fabricated from a conductive material. For example, the ball 306 may be fabricated from a metal, conductive polymer or a polymeric material filled with conductive material, such as metals, conductive carbon or graphite, among other conductive materials. Alternatively, the ball 306 may be formed from a solid or hollow core that is coated with a conductive material. The core may be non-conductive and at least partially coated with a conductive covering.

The ball 306 is generally actuated toward the planarizing surface 126 by at least one of spring, buoyant or flow forces. In the embodiment depicted in FIG. 5, flow through the passages formed through the adapter 304 and clamp bushing 316 and the platen assembly 230 from the electrolyte source 248 urge the ball 306 into contact with the substrate during processing.

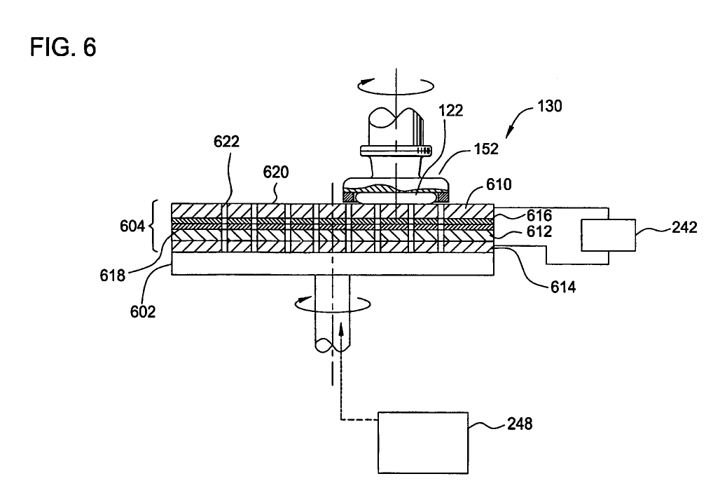

FIG. 6 is a sectional view of one embodiment of the second ECMP station 130. The first and third ECMP stations 128, 132 may be configured similarly. The second ECMP station 130 generally includes a platen 602 that supports a fully conductive processing pad assembly 604. The platen 602 may be configured similar to the platen assembly 230 described above to deliver electrolyte through the processing pad assembly 604, or the platen 602 may have a fluid delivery arm (not shown) disposed adjacent thereto configured to supply electrolyte to a planarizing surface of the processing pad assembly 604. The platen assembly 602 includes at least one of a meter or sensor 254 (shown in FIG. 2) to facilitate endpoint detection.

In one embodiment, the processing pad assembly 604 includes interposed pad 612 sandwiched between a conductive pad 610 and an electrode 614. The conductive pad 610 is substantially conductive across its top processing surface and is generally made from a conductive material or a conductive composite (i.e., the conductive elements are dispersed integrally with or comprise the material comprising the planarizing surface), such as a polymer matrix having conductive particles dispersed therein or a conductive coated fabric, among others. The conductive pad 610, the interposed pad 612, and the electrode 614 may be fabricated into a single, replaceable assembly. The processing pad assembly 604 is generally permeable or perforated to allow electrolyte to pass between the electrode 614 and top surface 620 of the conductive pad 610. In the embodiment depicted in FIG. 6, the processing pad assembly 604 is perforated by apertures 622 to allow electrolyte to flow therethrough. In one embodiment, the conductive pad 610 is comprised of a conductive material disposed on a polymer matrix disposed on a conductive fiber, for example, tin particles in a polymer matrix disposed on a woven copper coated polymer. The conductive pad 610 may also be utilized for the contact assembly 250 in the embodiment of FIG. 3C.

A conductive foil 616 may additionally be disposed between the conductive pad 610 and the subpad 612. The foil 616 is coupled to a power source 242 and provides uniform distribution of voltage applied by the source 242 across the conductive pad 610. In embodiments not including the conductive foil 616, the conductive pad 610 may be coupled directly, for example, via a terminal integral to the pad 610, to the power source 242. Additionally, the pad assembly 604 may include an interposed pad 618, which, along with the foil 616, provides mechanical strength to the overlying conductive pad 610. Examples of suitable pad assemblies are described in the previously incorporated U.S. patent applications Ser. Nos. 10/455,941 and 10/455,895.

Referring back to FIG. 1, the pretreatment station 160 is adapted to expose the substrate to a pretreatment fluid. The pretreatment fluid causes a passivation layer to form on the surface of the substrate. The pretreatment station 160 may be positioned or incorporated in the cleaning module 116, planarizing module 106, factory interface 102, or other suitable location in the system 100. In one exemplary embodiment, the pretreatment station 160 is in the form of a soak tank 198 positioned in the cleaning module 116. A to-be-polished substrate 122 is disposed to a pretreatment fluid in the soak tank 198 by the loading robot 104 prior to being transferring to the planarizing module 106. In another example, the pretreatment station 160 may be incorporated within one of the planarizing stations 128, 130, 132, or elsewhere in the planarizing module 106 for pretreating the substrate during different stages of the planarization process before or during polishing.

The substrate 122 may be pretreated in the pretreatment station 160 in any suitable manner. In one embodiment, the substrate may pretreated by immersing, dipping, or the like the substrate to a pretreatment fluid within a pretreatment station, such as the soak tank 198. In another embodiment, the substrate may be pretreated by spraying, rinsing, or exposing the substrate to the pretreatment fluid within a pretreatment station 160. In yet another embodiment, the substrate may be pretreated by exposing the substrate disposed in the planarizing station 128 to the pretreatment fluid prior polishing.

The pretreatment fluid may be a solution containing corrosion inhibitors. Suitable corrosion inhibitors include compounds having a nitrogen atom (N), such as organic compounds having azole groups. Examples of suitable compounds include benzotriazole (BTA), mercaptobenzotriazole, 5-methyl-1-benzotriazole (TTA), and combinations thereof. Other suitable corrosion inhibitors include film forming agents that are cyclic compounds, for example, imidazole, benzimidazole, triazole, and combinations thereof. Derivatives of benzotriazole, imidazole, benzimidazole, triazole, with hydroxy, amino, imino, carboxy, mercapto, nitro and alkyl substituted groups may also be used as corrosion inhibitors. Other corrosion inhibitor includes urea and thiourea among others. In one embodiment, the corrosion inhibitor contained within the solution may include between about 0.001% and about 5% by weight of the organic compound from one ore more azole groups, and the PH of the solution is maintained at between about 3 to about 9. In another embodiment, the solution may include between about 0.1 wt % and about 1 wt % of the organic compound from one ore more azole groups, and the PH thereof is maintained at between about 4 to about 8. In yet another embodiment, the solution may include between about 0.3 wt % and about 0.5 wt % by weight of the organic compound from one ore more azole groups, and the PH thereof is maintained at between about 5 to about 7.

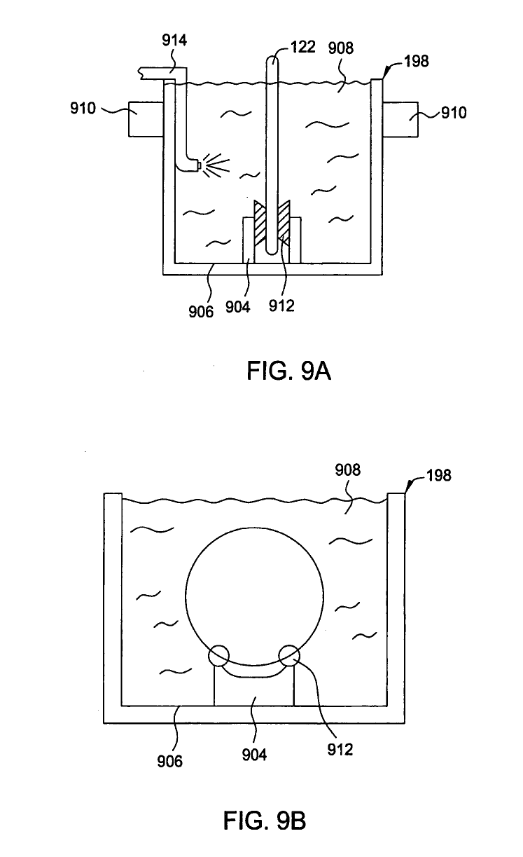

FIGS. 9A-B illustrate side and a front views of one embodiment of the soak tank 198. In FIG. 9A, the soak tank 198 contains a pretreatment fluid 908. An overflow weir 910 is provided at an upper portion of the soak tank 198 to catch any pretreatment fluid 908 which may overflow from the soak tank 198. The substrate 122 is supported in the soak tank 198 in a vertical position by two or more rollers 912. The rollers 912 may be provided to support the substrate 122 above the pretreatment fluid 908, or at least partially in the pretreatment fluid 908. In one embodiment, the substrate is completely submerged in the fluid 908.

The rollers 912 may be mounted to the soak tank 198 by a mounting arrangement 904. As shown in FIGS. 9A-B, the mounting arrangement 904 is attached to a wall 906 of the soak tank 198. In one embodiment, at least one nozzle 914, as shown in FIG. 9A, is associated with the soak tank 198 and configured to spray pretreatment fluid 908 to the surface of the substrate 122 retained on the rollers to perform the pretreatment process.

Polishing Processes

Methods are provided for polishing a substrate utilizing a pretreatment step to remove residues and achieve surface planarzation of the substrate, while increasing throughput and better surface finish and uniformity. In one embodiment, the methods may be performed by an electrochemical polishing technique, which included a combination of chemical activity, mechanical activity and electrical activity to remove conductive materials and planarize a substrate surface. In another embodiment, the methods may be performed by a conventional chemical mechanical polishing technique, which primarily removes conductive material by chemical and mechanical activities.

In one aspect, the method may include processing a substrate having a conductive material layer disposed over features, providing a pretreatment on the conductive material, supplying a first polishing fluid, or bulk polishing fluid, to the surface of the substrate, applying a first pressure between the substrate and a polishing article, providing relative motion between the substrate and the polishing article, applying a first bias between a first electrode and a second electrode in electrical contact with the substrate, removing a portion, such as at least about 50 percent, of the conductive material, supplying a second polishing fluid, or residual polishing fluid, to the surface of the substrate, applying a second pressure between the substrate and a polishing article, providing relative motion between the substrate and the polishing article, applying a second bias between a first electrode and a second electrode in electrical contact with the substrate, and removing residual conductive material from the substrate surface.

Prior to the bulk copper conductive layer removal, the surface pretreatment is performed by exposing the surface of the substrate to the pretreatment fluid. In one embodiment, the surface may be pretreated by spraying or flowing a pretreatment fluid to the surface of the substrate in a soak tank. In another embodiment, the surface of the substrate may be pretreated by immersing the substrate to the pretreatment fluid. In yet another embodiment, the surface of the substrate may be pretreated by soaking, dipping, rinsing, watering, exposing, wetting, or any suitable methods to the pretreatment fluid.

The removal of conductive material from the substrate may be performed in one or more processing steps, for example, a single removal step or a bulk removal step followed by a residual removal step. Bulk material is broadly defined herein as any material deposited on the substrate in an amount more than sufficient to substantially fill features formed on the substrate surface. Residual material is broadly defined as any material remaining after one or more bulk or residual polishing process steps. Generally, in a two step process, the bulk removal during a first electrochemical mechanical polishing process removes at least about 50% of the conductive layer, preferably at least about 70%, more preferably at least about 80%, for example, at least about 90%. The residual removal during a second electrochemical mechanical polishing process removes most, if not all the remaining conductive material disposed on the barrier layer to leave behind the filled plugs.

The bulk removal electrochemical mechanical polishing process may be performed on a first polishing station and the residual removal electrochemical mechanical polishing process on a second polishing station of the same or different polishing apparatus as the first station. In another embodiment of the two-step process, the residual removal electrochemical mechanical polishing process may be performed on the same station with the bulk removal process. Any barrier material may be removed on a separate station, such as the third station in the apparatus described in FIG. 1. In such an apparatus, the bulk and the residual processes are electrochemical mechanical polishing processes and the barrier removal is a CMP process or another electrochemical mechanical polishing process. In another embodiment, three electrochemical mechanical polishing station may be used to remove bulk material, residual removal and barrier removal.

While the following processes and compositions (e.g., polishing fluids) are described for removing copper, the invention contemplates that the compositions and processes herein also may be used for the removal of other conductive materials, such as aluminum, platinum, tungsten, titanium, titanium nitride, tantalum, tantalum nitride, cobalt, gold, silver, ruthenium and combinations thereof.

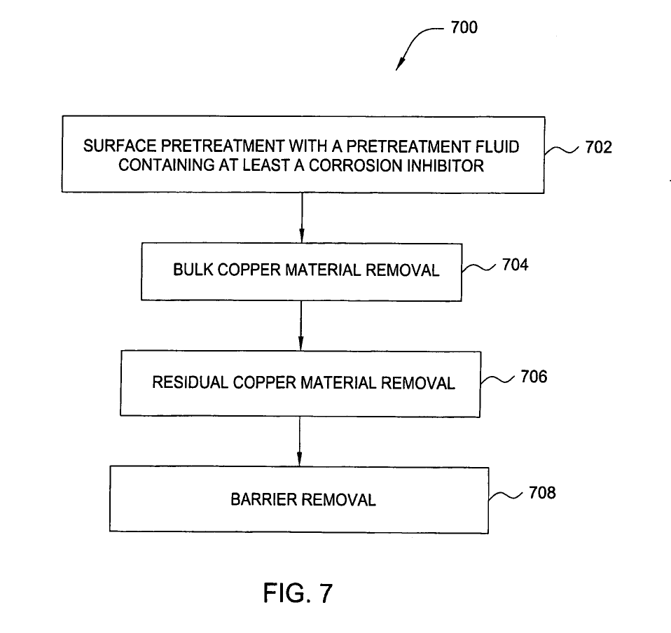

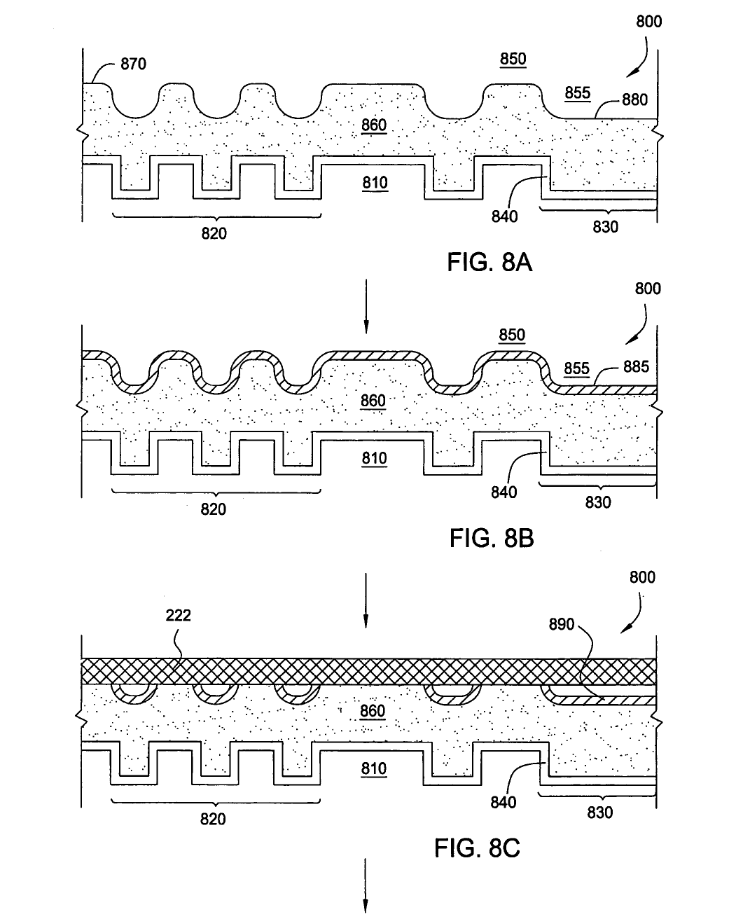

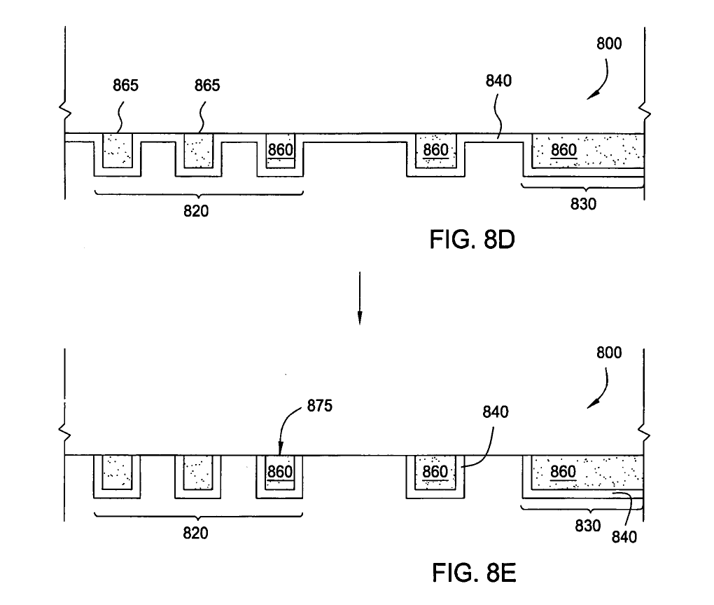

FIG. 7, illustrates a flow chart of an exemplary process 700 for polishing a conductive layer in an ECMP system. FIGS. 8A-8E are schematic cross-sectional views corresponding to process 700 to illustrate a surface pretreatment and polishing process performed on a substrate according to one embodiment of the invention. The method 700 begins at step 702 where a surface pretreatment is performed to form a passivation layer thereon prior to the first electrochemical mechanical polishing process as shown in FIGS. 8A-B. At step 704, a first electrochemical mechanical polishing proces used to remove bulk conductive material (for example, copper) from the substrate surface, as shown in FIG. 8C. At step 706, a second electrochemical mechanical polishing process to remove residual copper materials, as shown in FIG. 8D. Optionally, the surface pretreatment may be performed prior to performing the polishing process of step 706. Subsequent processes of step 708, such as barrier removal and buffering are used to produce the structure shown in FIG. 8E. The pretreatment may be performed to form a passivation layer to protect the surface of copper layer prior to the first and/or the second electrochemical mechanical polishing process. The first electrochemical mechanical polishing process produces to a fast removal rate of the copper layer and the second electrochemical mechanical polishing process, due to the precise removal of the remaining copper material, and forms level substrate surfaces with reduced or minimal dishing and erosion of substrate features.

FIG. 8A is a schematic cross-sectional view illustrating one embodiment of a to-be-polished substrate having at least a conductive layer disposed thereon. An uneven surface may be present after conductive layer deposition. The substrate 800 has a dielectric layer 810 patterned with narrow feature definitions 820 and wide feature definitions 830. The narrow feature definitions 820 and wide feature definitions 830 have a barrier material 840, for example, titanium and/or titanium nitride, or alternatively, tantalum and/or tantalum nitride, deposited therein, followed by a fill of a conductive material 860, for example, copper. The deposition profile of the excess material includes a high overburden 870, also referred to as a hill or peak, formed over narrow feature definitions 820 and a minimal overburden 880, also referred to as a valley, formed over wide feature definitions 830. Generally, the high overburden 870, formed over narrow feature definitions 820, refers as substrate field area 850. The minimal overburden 880, formed over wide feature definition 830, often refers as substrate trench area 855.

The terms narrow and wide feature definitions may vary depending on the structures formed on the substrate surface, but can generally be characterized by the respective deposition profiles of excessive material deposition (or high overburden) formed over narrow feature definitions and minimal or low material deposition (minimal or low overburden), over wide feature definitions. For example narrow feature definitions may be about 0.13 μm in size and may have a high overburden as compared to wide feature definitions that may be about 10 μm in size and that may have minimal or low overburden. However, high overburdens and low overburdens do not necessarily have to form over features, but may form over areas on the substrate surface between features.

The dielectric layer 810 may comprise one or more dielectric materials conventionally employed in the manufacture of semiconductor devices. For example, dielectric materials may include materials such as silicon dioxide, phosphorus-doped silicon glass (PSG), boron-phosphorus-doped silicon glass (BPSG), and silicon dioxide derived from tetraethyl orthosilicate (TEOS) or silane by plasma enhanced chemical vapor deposition (PECVD). The dielectric layer may also comprise low dielectric constant materials, including fluoro-silicon glass (FSG), polymers, such as polyamides, carbon-containing silicon oxides, such as Black Diamond™ dielectric material, silicon carbide materials, which may be doped with nitrogen and/or oxygen, including BLOK™ dielectric materials, available from Applied Materials, Inc., of Santa Clara, Calif.

A barrier layer 840 is disposed conformally in the feature definitions 820 and 830 and on the substrate 800. The barrier layer 840 may comprise metals or metal nitrides, such as tantalum, tantalum nitride, tantalum silicon nitride, titanium, titanium nitride, titanium silicon nitride, tungsten, tungsten nitride and combinations thereof, or any other material that may limit diffusion of materials between the substrate and/or dielectric materials and any subsequently deposited conductive materials.

A conductive material layer 860 is disposed on the barrier layer 840. The term “conductive material layer” as used herein is defined as any conductive material, such as copper, tungsten, aluminum, and/or their alloys used to fill a feature to form lines, contacts or vias. While not shown, a seed layer of a conductive material may be deposited on the barrier layer prior to the deposition of the conductive material layer 860 to improve interlayer adhesion and improve subsequent deposition processes. The seed layer may be of the same material as the subsequent material to be deposited.

One type of conductive material layer 860 comprises copper containing materials. Copper containing materials include copper, copper alloys (e.g., copper-based alloys containing at least about 80 weight percent copper) or doped copper. As used throughout this disclosure, the phrase “copper containing material,” the word “copper,” and the symbol “Cu” are intended to encompass copper, copper alloys, doped copper, and combinations thereof. Additionally, the conductive material may comprise any conductive material used in semiconductor manufacturing processing.

In step 702, the substrate is exposed to the pretreatment fluid. The substrate may be exposed by spraying, immersing, dipping, rinsing, wetting or other suitable methods. The substrate may be exposed in a pretreatment station containing a pretreatment fluid having at least one corrosion inhibitor. Examples of the pretreatment station 160 may be a soak tank 160, a planarization station 128, or other suitable station positioned on the system 100. In one embodiment, the substrate may be pretreated by the solution for about 0.1 second to about 50 seconds. In another embodiment, the substrate may be pretreated for about 1 second to about 30 seconds. In yet another embodiment, the substrate may be pretreated for about 5 seconds to about 20 seconds, for example, 10 seconds.

The corrosion inhibitor tends to form a passivation layer 885 in step 702 over the substrate surface, as shown in FIG. 8B, which minimizes the chemical interaction between the substrate surface and the surrounding electrolyte introduced from the subsequent polishing step. The passivation layer 885 forms on the exposed conductive material 860 on the substrate surface including the field area 850 and trench area on the surface of the deposited conductive material 860. The passivation layer tends to suppress or minimize the electrochemical current from the substrate surface to limit electrochemical deposition and/or dissolution, thereby chemically and/or electrically insulating the surface of the substrate from chemical and/or electrical reactions during polishing.

In step 704, a first electrochemical mechanical polishing is performed for removal of bulk copper material from the substrate, as shown in FIG. 8C. The process of step 704 is performed in the first Ecmp station 128. During the Ecmp process, a polishing fluid is provided at a flow rate between about 50 and about 800 milliliters per minute, such as about 300 milliliters per minute, to the substrate surface to establish a current path between the substrate and the electrode.

An example of the first polishing fluid for the bulk removal step includes between about 1 wt percent and about 10 wt percent of phosphoric acid, between about 0.1 wt percent and about 6 wt percent of the at least one chelating agent, between about 0.01 wt percent and about 1 wt percent of the corrosion inhibitor, between about 0.5 wt percent and about 10 wt percent of an inorganic or organic salt, between about 0.2 wt percent and about 5 wt percent of an oxidizer, and between about 0.05 wt percent and about 1 wt percent of abrasive particulates. The polishing fluid has a conductivity of between about 60 and about 64 milliSiemens/centimeter(mS/cm). The process may be performed with a composition temperature between about 20 degrees Celsius and about 60 degrees Celsius.

The substrate is pressed against the pad assembly 222 at a pressure less than about 2 pounds per square inch (lb/in² or psi) (13.8 kPa). The contact pressure may include a pressure of about 1 psi (6.9 kPa) or less, for example, between about 0.01 psi (69 Pa) and about 1 psi (6.9 kPa), such as between about 0.1 (0.7 kPa) psi and about 0.8 psi (5.5 kPa) or between about 0.1 (0.7 kPa) psi and less than about 0.5 psi (3.4 kPa). In one aspect of the process, a pressure of about 0.3 psi (2.1 kPa) or less is used.

Relative motion is provided between the substrate surface and the pad assembly 222 to reduce or remove the passivation layer 885. In one embodiment, pad assembly 222 disposed on the platen is rotated at a rate between about 7 rpm and about 80 rpm, for example about 28 rpm. The substrate disposed in a carrier head may be rotated between about 7 rpm and about 80 rpm, for example, about 37 rpm. The respective rotational rates of the platen and carrier head are believed to provide reduced shear forces and frictional forces when contacting the polishing article and substrate. Both the carrier head rotational speed and the platen rotational speed may be between about 7 rpm and less than 40 rpm. In one aspect of bulk polishing process, the carrier head rotational speed may be greater than a platen rotational speed by a ratio of carrier head rotational speed to platen rotational speed of greater than about 1:1, such as a ratio of carrier head rotational speed to platen rotational speed between about 1.5:1 and about 12:1, for example between about 1.5:1 and about 3:1, to remove material from the substrate surface.

A first bias from a power source 242 is applied between the two electrodes. The bias may be transferred from a conductive pad and/or electrode in the polishing article assembly 222 to the substrate 208. The bias may be applied by an electrical pulse modulation technique providing at least anodic dissolution.

The first bias is generally provided to produce anodic dissolution of the conductive material from the surface of the substrate at a current density up and about 100 mA/cm² which correlates to an applied current of about 40 amps to process substrates with a diameter up and about 300 mm. For example, a 200 mm diameter substrate may have a current density between about 0.01 mA/cm² and about 50 mA/cm², which correlates to an applied current between about 0.01 A and about 20 A. The invention also contemplates that the bias may be applied and monitored by volts, amps and watts. For example, in one embodiment, the power supply may apply a power between about 0.01 watts and 100 watts, a voltage between about 0.01 V and about 10 V, and a current between about 0.01 amps and about 10 amps. The bias between about 2.6 volts and about 3.5 volts, such as 3 volts, may be used as the applied bias in the first electrochemical processing step.

The passivation layer may be formed from the exposure of the substrate surface to the corrosion inhibitor and/or other materials contained in the first polishing fluid capable of forming a passivating or insulating film, for example, chelating agents. The thickness and density of the passivation layer can dictate the extent of chemical reactions and/or amount of anodic dissolution. For example, a thicker or denser passivation layer has been observed to result in less anodic dissolution compared to thinner and less dense passivation layers. Thus, control of the composition of passivating agents, corrosion inhibitors and/or chelating agents, allow control of the removal rate and amount of material removed from the substrate surface

A higher removal rate may be obtained by using comparatively lower concentration of the corrosion inhibitor contained in the first polishing fluid. In one embodiment, the concentration of the corrosion inhibitor may be between about 0.01 wt % to about 0.2 wt %. As described above, removal rate may be highly associated with the composition of passivating agents, e.g. corrosion inhibitor, contained in the polishing fluid. In present application, a pretreatment step includes exposing the substrate to a pretreatment fluid containing at least one added corrosion inhibitor therein, thereby forming a passivation layer on the surface of the conductive layer prior to the first electrochemical mechanical polishing step. Thus, as there is no need to conventionally form a passivation layer at the beginning of an electrochemical process since the passivation layer has been already formed in the pretreatment station 160 prior to processing, a relatively lower amount of corrosion inhibitor may be used in the polishing fluid, thereby increasing the removal rate. As such, the pretreatment beneficially increases the tool throughput while reducing overall process time.

A removal rate of conductive material of up and about 1,5000 Å/min can be achieved by the processes described herein. Higher removal rates are generally desirable, but due to the goal of maximizing process uniformity and other process variables (e.g., reaction kinetics at the anode and cathode), it is common for dissolution rates to be controlled between about 100 Å/min and about 15,000Å/min. In the present application, since the to-be-polished substrate has formed a passivation layer in the pretreatment step, a higher removal rate and better surface finish may be achieved by lowering the concentration of the corrosion inhibitor of the polishing fluid in the first electrochemical mechanical polishing step. In one embodiment of the invention where the copper material to be removed is less than 5,000 Å thick, the voltage (or current) may be applied to provide a removal rate between about 1000 Å/min and about 10,000 Å/min. The substrate is typically exposed to the polishing fluid and power application for a period of time sufficient to remove at least a portion or all of the desired material disposed thereon.

Residual material is removed with a second electrochemical mechanical polishing process. The second electrochemical mechanical polishing process provides a reduced removal rate compared to the first electrochemical mechanical polishing process step in order to prevent excess metal removal from forming topographical defects, such as concavities or depressions known as dishing and erosion as well as reducing delamination during polishing. Therefore, a majority of the conductive layer 860 is removed at a faster rate during the first electrochemical mechanical polishing process than the remaining or residual conductive layer 860 during the second electrochemical mechanical polishing process. The two-step electrochemical mechanical polishing process increases throughput of the total substrate processing while producing a smooth surface with little or no defects.

After performing the polishing is step 704, FIG. 8C illustrates the initiation of the second electrochemical mechanical polishing step. After the first electrochemical mechanical polishing process, conductive material 860 may still include the high overburden 870, peaks, and/or minimal overburden 880, valleys, but with a reduced proportional size. However, conductive material 860 may also be rather planar across the entire substrate surface (not shown).

In the second electrochemical mechanical polishing step, a second passivation layer 890 is formed from exposure of the conductive material to the polishing fluid. The second passivation layer 890 forms on the conductive material 860 exposed on the substrate surface. The second passivation layer 890 chemically and/or electrically insulates the surface of the substrate from chemical and/or electrical reactions.

The second, or residual removal, polishing fluid is provided to the substrate surface to provide a conductive path for the residual Ecmp process. The polishing fluid may be provided at a flow rate between about 50 and about 800 milliliters per minute, such as about 300 milliliters per minute, to the substrate surface.

The thickness and density of the second passivation layer 890 can dictate the extent of chemical reactions and/or amount of anodic dissolution. For example, a thicker or denser second passivation layer 890 has been observed to result in less anodic dissolution compared to thinner and less dense passivation layers. Thus, control of the pH of the polishing fluid, i.e., polymeric inhibitors and additional compounds, allow control of the removal rate and amount of material removed from the substrate surface.

In step 706, most, if not all of the conductive layer 860 is removed to expose barrier layer 840 and conductive trenches 865 by polishing the substrate in a second, residual, electrochemical mechanical polishing process, as shown in FIG. 8D. The conductive trenches 865 are formed by the remaining conductive material 860. The barrier material may then be polished by a third polishing step, as in step 708, to provide a planarized substrate surface containing conductive trenches 875, as depicted in FIG. 8E. The third polishing process may be a third electrochemical mechanical polishing process or a CMP process. An example of a barrier polishing process is disclosed in U.S. patent Ser. No. 10/193,810, entitled, “Dual Reduced Agents for Barrier Removal in Chemical Mechanical Polishing,” filed Jul. 11, 2002, published as United States Patent Publication Number 20030013306, which is incorporated herein to the extent not inconsistent with the claims aspects and disclosure herein. A further example of a barrier polishing process is disclosed in U.S. Patent Application Ser. No. 60/572,183 filed on May 17, 2004, which is incorporated herein to the extent not inconsistent with the claims aspects and disclosure herein.

After conductive material and barrier material removal processing steps, the substrate may then be buffed to minimize surface defects. Buffing may be performed with a soft polishing article, i.e., a pad having a hardness of about 40 or less Shore D, at reduced polishing pressures, such as about 2 psi or less.

Optionally, a cleaning solution may be applied to the substrate after each of the polishing processes to remove particulate matter and spent reagents from the polishing process as well as help minimize metal residue deposition on the polishing articles and defects formed on a substrate surface. An example of a suitable cleaning solution is Electra Clean™, commercially available from Applied Materials, Inc., of Santa Clara, Calif.

Thus, the present application provides an improved method for planarizing a substrate. The method advantageously facilitates the efficiency of the removal of the conductive layers by creating a passivation layer on the substrate prior to polishing.

While the foregoing is directed to embodiments of the invention, other and further embodiments of the invention may be devised without departing from the basic scope thereof, and the scope thereof is determined by the claims that follow.

1. A method for removing a conductive material from a substrate, comprising:
pretreating a conductive surface of a substrate in an electrochemical planarization system by exposing the conductive surface to a pretreatment fluid; and
planarizing the pre-treated substrate in the system in the presence of a polishing fluid.

2. The method of claim 1, the step of pretreating the surface of the substrate further comprises:
at least partially immersing the substrate in a fluid containing at least a corrosion inhibitor.

3. The method of claim 1, the step of pretreating the surface of the substrate further comprises:
spraying the substrate with a fluid containing at least a corrosion inhibitor.

4. The method of claim 1, the step of pretreating the surface of the substrate further comprises:
applying the pretreatment fluid to the substrate by at least one of rinsing, wetting, flowing, dipping, watering or soaking.

5. The method of claim 1, the step of pretreatment the surface of the substrate further comprises:
placing the substrate in a pretreatment station.

6. The method of claim 5, wherein the pretreatment station is in a factory interface.

7. The method of claim 5, wherein the pretreatment station is a cleaning module.

8. The method of claim 5, wherein the pretreatment station is a polishing module.

9. The method of claim 1, wherein the pretreatment fluid further comprises:
at least one corrosion inhibitor having a concentration between about 0.01 and 1 percent by weight.

10. The method of claim 1, wherein the pretreatment fluid has a PH at between about 3 and about 9.

11. The method of claim 1, the step of polishing the substrate further comprising:
contacting the substrate to a polishing pad assembly; and
providing a relative motion between the substrate and the polishing pad assembly.

12. The method of claim 11 further comprising:
applying a electrical bias to the substrate.

13. The method of claim 2, wherein the corrosion inhibitor is an organic compound having azole group.

14. The method of claim 13, wherein the corrosion inhibitor is selected from the group organic compounds comprising benzotriazole, mercaptobenzotriazole, 5-methyl-1-benzotriazole, and combinations thereof.

15. The method of claim 1, wherein the conductive layer comprises copper or a copper alloy.

16. The method of claim 1, wherein the pretreatment fluid is different from the polishing fluid.

17. The method of claim 1, wherein the step of pretreating further comprises:
forming a passivation layer on the surface of the substrate.

18. A method for removing a conductive material from a substrate, comprising:
pretreating a conductive surface of a substrate in an electrochemical processing system by exposing the conductive surface to a pretreatment fluid comprising a corrosion inhibitor; and
planarizing the pretreated substrate in the system in the presence of a polishing fluid.

19. The method of claim 18, the step of pretreatment the surface of the substrate further comprises:
pretreating the substrate in a soak tank.

20. The method of claim 18, the step of pretreatment the surface of the substrate further comprises:
pretreating the substrate in a planarizing station.

21. The method of claim 18, wherein the corrosion inhibitor is an organic compound having azole group.

22. The method of claim 18, wherein the corrosion inhibitor is selected from a the group of organic compounds comprising benzotriazole, mercaptobenzotriazole, 5-methyl-1-benzotriazole, and combinations thereof.

23. The method of claim 18, wherein the conductive layer comprises copper or a copper alloy.

24. The method of claim 18, wherein the step of pretreating the surface further comprises:
forming a passivation layer on the surface of the substrate.

25. A method for removing a conductive material from a substrate, comprising:
passivating a conductive surface of a substrate by exposing the conductive surface to a pretreatment fluid;
exposing the substrate to a polishing fluid;
contacting the passivated surface of substrate to a polishing surface;
applying an electrical bias to the conductive surface;
providing a relative motion between the substrate and the polishing surface; and
removing a portion of the conductive surface to planarize the substrate.
